(19) United States
(12) Patent Application Publication
(10) Pub. No.: US 2018/0312699 A1
(43) Pub. Date: Nov. 1, 2018

(54) Water-Based Primer Composition for Sealant

(71) Applicant: The Yokohama Rubber Co., LTD., Minato-ku, Tokyo (JP)

(72) Inventors: Hisae Akiyama, Hiratsuka-shi, Kanagawa (JP); Takahiro Okamatsu, Hiratsuka-shi, Kanagawa (JP)

(21) Appl. No.: 15/768,503

(22) PCT Filed: Oct. 12, 2016
(86) PCT No.: PCT/JP2016/080253

§ 371 Date: Apr. 13, 2018

(30) Foreign Application Priority Data
Oct. 13, 2015 (JP) 2015-202167
Oct. 13, 2015 (JP) 2015-202225

(51) Int. Cl. C09D 5/00; C09D 5/02; C09D 4/00; C09D 133/12; C08F 220/14

(52) U.S. Cl. CPC C09D 5/002; C09D 5/022; C08F 2810/50; C09D 133/12; C08F 220/14; C09D 4/00

(57) ABSTRACT

A water-based primer composition contains a (meth)acrylic emulsion containing a (meth)acrylic particle and a tertiary amine (B), the (meth)acrylic particle being a particle of a polymer obtained by polymerizing a polymerizable monomer (A) having a (meth)acryloyl group; the polymerizable monomer (A) containing an epoxy group-containing polymerizable monomer or a phosphoric acid group-containing polymerizable monomer having a phosphoric acid group, a (meth)acrylic acid alkyl ester monomer, a (meth)acrylic acid monomer, and a hydroxy group-containing polymerizable monomer, and, in the case where the polymerizable monomer (A) contains the epoxy group-containing polymerizable monomer, further containing a (meth)acrylic silane coupling agent, and a content of the (meth)acrylic particle being from 15 to 60 mass %.

### TECHNICAL FIELD

The present technology relates to a water-based primer composition for a sealant.

### BACKGROUND ART

In general, to adhere a sealant for construction to an adherend formed from an inorganic hard material, such as mortar, a primer needs to be applied to the adherend.

To reduce environmental pollution as much as possible and to further enhance safety and health of workers, development of water-based primers is currently demanded.

The applicant of the present application has proposed, for example, Japan Unexamined Patent Publication No. 2014-172992 as a water-based primer composition.

Japan Unexamined Patent Publication No. 2014-172992 describes a water-based primer composition, containing an acrylic emulsion, for a sealant, the water-based primer composition being an acrylic emulsion containing acrylic particles;

an average particle diameter of the acrylic particles being 0.6 μm or less;

the acrylic particles being particles of polymer obtained by subjecting a polymerizable monomer (A) containing a (meth)acryloyl group in the presence of a persulfate (B) which is a polymerization initiator;

the polymerizable monomer (A) containing a (meth)acrylic acid alkyl ester monomer (A1) and a hydroxy group-containing polymerizable monomer

(A2) having a hydroxy group;

a molar ratio (B/A1) of the persulfate (B) to the (meth)acrylic acid alkyl ester monomer (A1) being 0.007 or greater;

a molar ratio (OH/A1) of the hydroxy group (OH) contained in the hydroxy group-containing polymerizable monomer (A2) to the (meth)acrylic acid alkyl ester monomer (A1) being 0.05 or greater; and
a solid content being 15 mass % or greater but less than 40 mass %.

The inventors of the present technology prepared and evaluated a primer composition by using Japan Unexamined Patent Publication No. 2014-172992 as a reference, and found that there are some cases where such a primer composition may have poor water resistance.

### SUMMARY

The present technology provides a water-based primer composition for a sealant, the water-based primer composition having excellent water resistance.

The inventors of the present technology found that a predetermined effect can be achieved by a water-based primer composition for a sealant, the water-based primer composition containing a (meth)acrylic emulsion containing a (meth)acrylic particle and a tertiary amine (B),

the (meth)acrylic particle being a particle of a polymer obtained by polymerizing a polymerizable monomer (A) having a (meth)acryloyl group;

the polymerizable monomer (A) containing an epoxy group-containing polymerizable monomer (A1) having an epoxy group, a (meth)acrylic silane coupling agent (A2), a (meth)acrylic acid alkyl ester monomer (A3), a (meth)acrylic acid monomer (A4), and a hydroxy group-containing polymerizable monomer (A5) having a hydroxy group, or

the polymerizable monomer (A) containing a phosphoric acid group-containing polymerizable monomer (AP) having a phosphoric acid group, a (meth)acrylic acid alkyl ester monomer (A6), a (meth)acrylic acid monomer (A7), and a hydroxy group-containing polymerizable monomer (A8) having a hydroxy group, and

a content of the (meth)acrylic particle being from 15 to 60 mass %.

The present technology provides the following features.

1. A water-based primer composition for a sealant, the water-based primer composition containing a (meth)acrylic emulsion containing a (meth)acrylic particle and a tertiary amine (B),

the (meth)acrylic particle being a particle of a polymer obtained by polymerizing a polymerizable monomer (A) having a (meth)acryloyl group;

the polymerizable monomer (A) containing an epoxy group-containing polymerizable monomer (A1) having an epoxy group, a (meth)acrylic silane coupling agent (A2), a (meth)acrylic acid alkyl ester monomer (A3), a (meth)acrylic acid monomer (A4), and a hydroxy group-containing polymerizable monomer (A5) having a hydroxy group, and

a content of the (meth)acrylic particle being from 15 to 60 mass %.

2. The water-based primer composition for a sealant according to 1 above, where a molar ratio (A1/A3) of the epoxy group-containing polymerizable monomer (A1) to the (meth)acrylic acid alkyl ester monomer (A3) is from 0.02 to 0.12.

3. The water-based primer composition for a sealant according to 1 or 2 above, where a molar ratio (A2/A3) of the (meth)acrylic silane coupling agent (A2) to the (meth)acrylic acid alkyl ester monomer (A3) is from 0.01 to 0.07.

4. The water-based primer composition for a sealant according to any one of 1 to 3 above, where a molar ratio (A4/A3) of the (meth)acrylic acid monomer (A4) to the (meth)acrylic acid alkyl ester monomer (A3) is from 0.05 to 0.2.

5. The water-based primer composition for a sealant according to any one of 1 to 4 above, where a molar ratio (A5/A3) of the hydroxy group-containing polymerizable monomer (A5) to the (meth)acrylic acid alkyl ester monomer (A3) is from 0.08 to 0.18.

6. The water-based primer composition for a sealant according to any one of 1 to 5 above, where a molar ratio (B/A4) of the tertiary amine (B) to the (meth)acrylic acid monomer (A4) is from 0.2 to 1.0.

(1) A water-based primer composition for a sealant, the water-based primer composition containing a (meth)acrylic emulsion containing a (meth)acrylic particle and a tertiary amine (B),

the (meth)acrylic particle being a particle of a polymer obtained by polymerizing a polymerizable monomer (A) having a (meth)acryloyl group;

the polymerizable monomer (A) containing a phosphoric acid group-containing polymerizable monomer (AP) having a phosphoric acid group, a (meth)acrylic acid alkyl ester monomer (A6), a (meth)acrylic acid monomer (A7), and a hydroxy group-containing polymerizable monomer (A8) having a hydroxy group; and

a content of the (meth)acrylic particle being from 15 to 60 mass %.

(2) The water-based primer composition for a sealant according to (1) above, where a molar ratio (AP/A6) of the phosphoric acid group-containing polymerizable monomer (AP) to the (meth)acrylic acid alkyl ester monomer (A6) is 0.04 or less.

(3) The water-based primer composition for a sealant according to (1) or (2) above, where a molar ratio (A7/A6) of the (meth)acrylic acid monomer (A7) to the (meth)acrylic acid alkyl ester monomer (A6) is from 0.05 to 0.15.

(4) The water-based primer composition for a sealant according to any one of (1) to (3) above, where a molar ratio (A8/A6) of the hydroxy group-containing polymerizable monomer (A8) to the (meth)acrylic acid alkyl ester monomer (A6) is from 0.05 to 0.1.

(5) The water-based primer composition for a sealant according to any one of (1) to (4) above, where a molar ratio (B/A7) of the tertiary amine (B) to the (meth)acrylic acid monomer (A7) is from 0.1 to 1.0.

The water-based primer composition for a sealant of an embodiment of the present technology has excellent water resistance.

### DETAILED DESCRIPTION

Embodiments of the present technology are described in detail below.

Note that, in the present specification, (meth)acrylate represents acrylate or methacrylate, (meth)acryloyl represents acryloyl or methacryloyl, and (meth)acryl represents acryl or methacryl.

Furthermore, in the present specification, numerical ranges indicated using “(from) . . . to . . . ” include the former number as the lower limit value and the later number as the upper limit value.

In the present specification, when a component contains two or more types of substances, the content of the component means the total content of the two or more types of substances.

In the present specification, the cases where water resistance is superior may be referred to as “exhibiting superior effect of the present technology”.

In the present specification, the epoxy group-containing polymerizable monomer (A1) may be referred to as a monomer (A1), (A1), or A1. Besides the epoxy group-containing polymerizable monomer (A1), the same applies to the (meth)acrylic silane coupling agent (A2), the (meth)acrylic acid alkyl ester monomer (A3), the (meth)acrylic acid monomer (A4), the hydroxy group-containing polymerizable monomer (A5), the phosphoric acid group-containing polymerizable monomer (AP), the (meth)acrylic acid alkyl ester monomer (A6), the (meth)acrylic acid monomer (A7), and the hydroxy group-containing polymerizable monomer (A8).

Furthermore, in the present specification, when the polymerizable monomer (A) contains (A1) to (A5), the polymerizable monomer (A) may be referred to as “first monomer composition”, and when the polymerizable monomer (A) contains (AP) and (A6) to (A8), the polymerizable monomer (A) may be referred to as “second monomer composition”.

### Water-Based Primer Composition for Sealant

The water-based primer composition for a sealant of an embodiment of the present technology (the composition of an embodiment of the present technology) is

a water-based primer composition for a sealant, the water-based primer composition containing a (meth)acrylic emulsion containing a (meth)acrylic particle and a tertiary amine (B),

the (meth)acrylic particle being a particle of a polymer obtained by polymerizing a polymerizable monomer (A) having a (meth)acryloyl group;

the polymerizable monomer (A) containing an epoxy group-containing polymerizable monomer (A1) having an epoxy group, a (meth)acrylic silane coupling agent (A2), a (meth)acrylic acid alkyl ester monomer (A3), a (meth)acrylic acid monomer (A4), and a hydroxy group-containing polymerizable monomer (A5) having a hydroxy group, or

the polymerizable monomer (A) containing a phosphoric acid group-containing polymerizable monomer (AP) having a phosphoric acid group, a (meth)acrylic acid alkyl ester monomer (A6), a (meth)acrylic acid monomer (A7), and a hydroxy group-containing polymerizable monomer (A8) having a hydroxy group; and

a content of the (meth)acrylic particle being from 15 to 60 mass %.

The composition according to an embodiment of the present technology is thought to achieve desired effects as a result of having such a configuration. Although the reason is not clear, it is assumed to be as follows.

When the polymerizable monomer (A) is a first monomer composition in the composition of an embodiment of the present technology and such a composition is used as a primer, the epoxy group contained in a (meth)acrylic particle is subjected to ring opening by a tertiary amine (B) to produce a hydroxy group, and the interaction between the hydroxy group and at least a sealant suppresses infiltration of water and achieves excellent water resistance.

Furthermore, when the base material to which the sealant is applied is an inorganic material, such as mortar, the hydroxy group can interact with the inorganic material, and excellent water resistance is achieved.

Furthermore, the polymer main chain is crosslinked because, in the polymer constituting the (meth)acrylic particle, the polymer has epoxy groups, and some of the epoxy groups are ring-opened and bonded each other due to the catalytic effect of the tertiary amine (B). Therefore, excellent water resistance of the primer membrane formed after drying of emulsion is achieved compared to the case of a composition containing a low molecular weight compound having an epoxy group or the like.

Furthermore, when the polymerizable monomer (A) is a second monomer composition in the composition of an embodiment of the present technology, such a composition has excellent adhesion and water resistance.

This is caused because the composition more easily infiltrates into the adherend, such as mortar, and/or because the phosphoric acid group and an adherend can interact each other because the average particle size of the (meth)acrylic particle contained in the composition is decreased due to the phosphoric acid group contained in the (meth)acrylic particle.

Each of the components contained in the composition according to an embodiment of the present technology will be described in detail below.

### (Meth)Acrylic Emulsion

The (meth)acrylic emulsion contained in the composition of an embodiment of the present technology contains a (meth)acrylic particle as a dispersoid and a dispersion medium such as water, and the (meth)acrylic particle is dispersed (suspended) in the dispersion medium.

Note that, in the present technology, the phase of the (meth)acrylic particle as the dispersoid may be a liquid phase or a solid phase.

In general, a system in which a liquid phase dispersoid is dispersed in a liquid phase dispersion medium is called an “emulsion”, and a system in which a solid phase dispersoid is dispersed in a liquid phase dispersion medium is called a “suspension”. However, in the present technology, the term “emulsion” includes “suspension”.

The dispersion medium contains at least water. The dispersion medium may further contain an aqueous organic solvent such as alcohols, besides the water. An example of a preferable aspect is one in which the dispersion medium is distilled water.

In an embodiment of the present technology, the content of the (meth)acrylic particle is from 15 to 60 mass % relative to the total amount of the composition of the embodiment of the present technology. The content of the (meth)acrylic particle is preferably from 20 to 60 mass %, and more preferably from 25 to 60 mass %, relative to the total amount of the composition of an embodiment of the present technology from the perspective of achieving superior effect of the present technology and excellent adhesion and drying characteristics.

Note that, in an embodiment of the present technology, the content of the (meth)acrylic particle is influenced as is by the used amount of the polymerizable monomer (A) used in the production of the (meth)acrylic emulsion. The (meth)acrylic particle may contain an unreacted polymerizable monomer (A). The content of the (meth)acrylic particle does not include the amount of the polymerization initiator used to produce the (meth)acrylic particle and the amount of the tertiary amine contained in the composition of an embodiment of the present technology.

Furthermore, (meth)acrylic particle is the solid content of the (meth)acrylic emulsion.

### (Meth)Acrylic Particle

The (meth)acrylic particle contained in the (meth)acrylic emulsion is a particle of polymer obtained by polymerizing a polymerizable monomer (A) having a (meth)acryloyl group.

The main chain of the polymer may be any main chain that contains a repeating unit derived from a (meth)acryloyl group. The main chain of the polymer is preferably a (meth)acrylic polymer.

The (meth)acrylic particle (or the polymer constituting the (meth)acrylic particle) contains an epoxy group, a hydrolyzable silyl group (hydrolyzable silyl group may have a silanol group), an alkyl ester, a carboxy group, and a hydroxy group (hereinafter, these are also referred to as “epoxy groups and the like”) or contains a phosphoric acid group, an alkyl ester, a carboxy group, and a hydroxy group (hereinafter, these are also referred to as “phosphoric acid group and the like”).

In the (meth)acrylic particle, the carbonyl group contained in the repeating unit derived from (meth)acryloyl group may be bonded to the epoxy groups and the like or the phosphoric acid and the like directly or through an organic group. The carbonyl group may form the carboxy group or the alkyl ester.

The organic group is not limited. Examples thereof include a hydrocarbon group that may have a heteroatom.

The hydrocarbon group is not limited. Examples thereof include aliphatic hydrocarbon groups (including straight-chain, branched chain, and cyclic), aromatic hydrocarbon groups, and combinations thereof. The hydrocarbon group may have an unsaturated bond.

The heteroatom is not limited. Examples thereof include an oxygen atom, a nitrogen atom, a sulfur atom, and a halogen. The heteroatom may form a functional group by a combination of the heteroatoms, or the heteroatom and a carbon atom and/or a hydrogen atom. The heteroatom may be substituted with a carbon atom constituting the hydrocarbon group. Examples of the group that is formed by substituting the oxygen atom with the carbon atom constituting the hydrocarbon group include oxyalkylene groups and poly(oxyalkylene) groups.

The weight average molecular weight of the (meth)acrylic particle is preferably from 50000 to 400000, and more preferably from 70000 to 300000, from the perspective of superior effect of the present technology, excellent adhesion, wettability to an adherend, low viscosity, and the like.

Note that the weight average molecular weight (Mw) of acrylic particle is a weight average molecular weight represented in terms of polystyrene, which is determined by gel permeation chromatography (GPC) using tetrahydrofuran as a solvent.

The average particle size of the (meth)acrylic particle may be, for example, 0.6 μm or less and, from the perspective of wettability to an adherend, the average particle size is preferably 0.58 μm or less, and more preferably 0.55 μm or less.

On the other hand, from the perspective of achieving superior effect of the present technology and excellent adhesion, the lower limit value of the average particle size of the (meth)acrylic particle is preferably greater than 0.01 μm, more preferably 0.015 μm or greater, and even more preferably 0.02 μm or greater.

Note that the average particle size of the (meth)acrylic particle is a value measured by using a particle size distribution analyzer (Nanotrac UPA-EX150, available from Nikkiso Co., Ltd.).

### Polymerizable Monomer (A)

The polymerizable monomer (A) used in the production of the (meth)acrylic emulsion contains an epoxy group-containing polymerizable monomer (A1) having an epoxy group, a (meth)acrylic silane coupling agent (A2), a (meth)acrylic acid alkyl ester monomer (A3), a (meth)acrylic acid monomer (A4), and a hydroxy group-containing polymerizable monomer (A5) having a hydroxy group (first monomer composition).

Alternatively, the polymerizable monomer (A) used in the production of the (meth)acrylic emulsion contains a phosphoric acid group-containing polymerizable monomer (AP) having a phosphoric acid group, a (meth)acrylic acid alkyl ester monomer (A6), a (meth)acrylic acid monomer (A7), and a hydroxy group-containing polymerizable monomer (A8) having a hydroxy group (second monomer composition).

In the composition of an embodiment of the present technology, in both cases where the polymerizable monomer (A) is the first monomer composition and where the polymerizable monomer (A) is the second monomer composition, excellent water resistance is achieved, and excellent adhesion is achieved.

The case where the polymerizable monomer (A) is the first monomer composition is described below.

### Epoxy Group-Containing Polymerizable Monomer (A1)

The epoxy group-containing polymerizable monomer (A1) as the polymerizable monomer (A) is a compound having a (meth)acryloyl group and an epoxy group.

The (meth)acryloyl group and the epoxy group can be bonded through an organic group. The organic group is synonymous with that described above.

Examples of the epoxy group-containing polymerizable monomer (A1) include a compound represented by Formula (1) below.

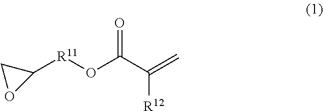

In Formula (1), R¹¹ is a hydrocarbon group that may have a heteroatom, and R¹² is a hydrogen atom or a methyl group.

The hydrocarbon group that may have a heteroatom (each of the heteroatom and the hydrocarbon group) is synonymous with that described above (the same applies hereinafter). The hydrocarbon group that may have a heteroatom is preferably an alkylene group that may have an ether bond.

Specific examples of the epoxy group-containing polymerizable monomer (A1) include glycidyl (meth)acrylate, and 4-hydroxybutyl(meth)acrylate glycidyl ether.

The epoxy group-containing polymerizable monomer (A1) can be used alone or in combination of two or more types thereof. In the present technology, the same applies to (A2) to (A8) and (AP) that are used as the polymerizable monomer (A).

### (Meth)Acrylic Silane Coupling Agent (A2)

The (meth)acrylic silane coupling agent (A2) as the polymerizable monomer (A) is a compound having a (meth)acryloyl group and a hydrolyzable silyl group.

Examples of the hydrolyzable group contained in the hydrolyzable silyl group include alkoxy groups and phenoxy groups.

The alkoxy group contained in the alkoxysilyl group (in the case where the hydrolyzable silyl group contains an alkoxy group as the hydrolyzable group) is not limited. Examples thereof include a methoxy group and an ethoxy group.

The number of the hydrolyzable group contained in one hydrolyzable silyl group may be from 1 to 3.

When the number of the hydrolyzable group contained in one hydrolyzable silyl group is from 1 to 2, the group except the hydrolyzable group bonded to the hydrolyzable silyl group is not limited. For example, hydrocarbons groups can be used. The hydrocarbon group is not limited. Examples thereof include the groups listed above. The hydrocarbon group is preferably an alkyl group, such as a methyl group or an ethyl group.

The number of the (meth)acryloyl group contained in one molecule of the (meth)acrylic silane coupling agent (A2) may be one or the plural number.

The number of the hydrolyzable silyl group contained in one molecule of the (meth)acrylic silane coupling agent (A2) may be one or a plurality.

In the (meth)acrylic silane coupling agent (A2), the (meth)acryloyl group and the hydrolyzable silyl group can be bonded through an organic group. The organic group is synonymous with that described above.

Examples of the (meth)acrylic silane coupling agent (A2) include γ-(meth)acryloxypropyltrimethoxysilane, γ-(meth)acryloxypropyltriethoxysilane, γ-(meth)acryloxypropyltripropoxysilane, γ-meth)acryloxypropylmethyldimethoxysilane, γ-(meth)acryloxypropylmethyldiethoxysilane, and γ-(meth)acryloxypropylmethyldipropoxysilane.

Among these, γ-methacryloxypropyltriethoxysilane and γ-methacryloxypropylmethyldiethoxysilane are preferable from the perspective of superior effect of the present technology and excellent adhesion and storage stability.

### (Meth)Acrylic Acid Alkyl Ester Monomer (A3)

The (meth)acrylic acid alkyl ester monomer (A3) as the polymerizable monomer (A) may be any alkyl ester of (meth)acrylic acid.

The alkyl group constituting the alkyl ester is not limited. The alkyl group may be a straight-chain, branched, or cyclic alkyl group.

Examples of the (meth)acrylic acid alkyl ester monomer (A3) include methyl (meth)acrylate, ethyl (meth)acrylate, propyl (meth)acrylate, n-butyl (meth)acrylate, isobutyl (meth)acrylate, sec-butyl (meth)acrylate, t-butyl (meth)acrylate, hexyl (meth)acrylate, 2-ethylhexyl (meth)acrylate, cyclohexyl (meth)acrylate, t-butylcyclohexyl (meth)acrylate, isoamyl (meth)acrylate, n-pentyl (meth)acrylate, isopentyl (meth)acrylate, cyclopentyl (meth)acrylate, n-octyl (meth)acrylate, isooctyl (meth)acrylate, cyclooctyl (meth)acrylate, n-nonyl (meth)acrylate, isononyl (meth)acrylate, n-decyl (meth)acrylate, isodecyl (meth)acrylate, n-dodecyl (meth)acrylate, isomyristyl (meth)acrylate, n-tridecyl (meth)acrylate, and n-tetradecyl (meth)acrylate.

Among these, methyl (meth)acrylate, ethyl (meth)acrylate, n-butyl (meth)acrylate, isobutyl (meth)acrylate, sec-butyl (meth)acrylate, t-butyl (meth)acrylate, 2-ethylhexyl (meth)acrylate, and the like are preferable. (Meth)acrylic acid monomer (A4)

Examples of the (meth)acrylic acid monomer (A4) as the polymerizable monomer (A) include (meth)acrylic acid.

### Hydroxy Group-Containing Polymerizable Monomer (A5)

The hydroxy group-containing polymerizable monomer (A5) as the polymerizable monomer (A) may be any compound having a (meth)acryloyl group and a hydroxy group.

The (meth)acryloyl group and the hydroxy group can be bonded through an organic group.

The organic group is not limited. The organic group is synonymous with that described above.

Examples of the hydroxy group-containing polymerizable monomer (A5) include a compound represented by Formula (2) below.

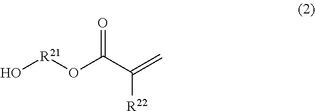

In Formula (2), R²¹ is a hydrocarbon group that may have a heteroatom, and R²² is a hydrogen atom or a methyl group.

The hydrocarbon group that may have a heteroatom is synonymous with that described above. The hydrocarbon group that may have a heteroatom is preferably an alkylene group.

Specific examples of the hydroxy group-containing polymerizable monomer (A5) include hydroxyethyl(meth)acrylate and 4-hydroxybutyl(meth)acrylate.

### Quantitative Ratio of Monomers

### A1/A3

The molar ratio (A1/A3) of the epoxy group-containing polymerizable monomer (A1) to the (meth)acrylic acid alkyl ester monomer (A3) is preferably from 0.02 to 0.12, and more preferably from 0.04 to 0.12, from the perspective of achieving superior effect of the present technology and excellent storage stability (also referred to as “stability”; the same applies hereinafter).

### A2/A3

The molar ratio (A2/A3) of the (meth)acrylic silane coupling agent (A2) to the (meth)acrylic acid alkyl ester monomer (A3) is preferably from 0.01 to 0.07, and more preferably from 0.014 to 0.07, from the perspective of achieving superior effect of the present technology and excellent stability.

### A4/A3

The molar ratio (A4/A3) of the (meth)acrylic acid monomer (A4) to the (meth)acrylic acid alkyl ester monomer (A3) is preferably from 0.05 to 0.2, and more preferably from 0.1 to 0.2, from the perspective of achieving superior effect of the present technology and excellent stability.

### A5/A3

The molar ratio (A5/A3) of the hydroxy group-containing polymerizable monomer (A5) to the (meth)acrylic acid alkyl ester monomer (A3) is preferably from 0.08 to 0.18, and more preferably from 0.08 to 0.15.

### Content of Epoxy Group-Containing Polymerizable Monomer (A1)

From the perspective of achieving superior effect of the present technology and excellent stability, the content of the epoxy group-containing polymerizable monomer (A1) is preferably from 1 to 10 mol %, and more preferably from 2 to 9 mol % relative to the total number of moles of the epoxy group-containing polymerizable monomer (A1), the (meth)acrylic silane coupling agent (A2), the (meth)acrylic acid alkyl ester monomer (A3), the (meth)acrylic acid monomer (A4), and the hydroxy group-containing polymerizable monomer (A5).

### Total Content of Epoxy Group-Containing Polymerizable Monomer (A1) and (Meth)Acrylic Silane Coupling Agent (A2)

From the perspective of achieving superior effect of the present technology, excellent stability, and excellent balance of water resistance and stability, the total content of the epoxy group-containing polymerizable monomer (A1) and the (meth)acrylic silane coupling agent (A2) is preferably from 1.5. to 10.5 mol %, and more preferably from 1.5 to 10 mol % relative to the total number of moles of the epoxy group-containing polymerizable monomer (A1), the (meth)acrylic silane coupling agent (A2), the (meth)acrylic acid alkyl ester monomer (A3), the (meth)acrylic acid monomer (A4), and the hydroxy group-containing polymerizable monomer (A5).

The case where the polymerizable monomer (A) is the second monomer composition is described below. Phosphoric acid group-containing polymerizable monomer (AP)

The phosphoric acid group-containing polymerizable monomer (AP) as the polymerizable monomer (A) is a compound having a (meth)acryloyl group and a phosphoric acid group.

In the phosphoric acid group, a total of 3 of hydroxy group(s) and oxygen atom(s) is bonded to a phosphorus atom constituting O=P, and the number of the hydroxy group(s) is 1 or 2.

As the phosphoric acid group, the following structure is exemplified.

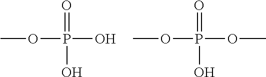

The (meth)acryloyl group and the phosphoric acid group can be bonded through an organic group. The organic group is synonymous with that described above.

Examples of the phosphoric acid group-containing polymerizable monomer (AP) include a compound represented by Formula (1) below.

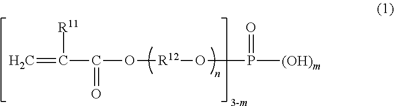

In Formula (1), R¹¹ is a hydrogen atom or a methyl group, R¹² is a hydrocarbon group that may have a heteroatom, m is 1 or 2, and n is from 1 to 9.

The hydrocarbon group that may have a heteroatom (each of the heteroatom and the hydrocarbon group) is synonymous with that described above (the same applies hereinafter). The hydrocarbon group that may have a heteroatom is preferably an alkylene group. Examples of the alkylene group include an ethylene group, a trimethylene group, and a propylene group.

From the perspective of achieving superior effect of the present technology and excellent adhesion, m is preferably 2.

n may be 1 or 2 to 9.

Specific examples of the phosphoric acid-containing polymerizable monomer (AP) include

acid phosphoxy alkylene(meth)acrylates, such as

acid phosphoxy ethylmono(meth)acrylate, and

acid phosphoxy propylene mono(meth)acrylate; and

acid phosphoxy polyoxyalkylene glycol (meth)acrylates, such as

acid phosphoxy polyoxyethyl glycol mono(meth)acrylate, and

acid phosphoxy polyoxypropylene glycol mono(meth)acrylate.

Among these, acid phosphoxy ethylmono(meth)acrylate and acid phosphoxy polyoxypropylene glycol mono(meth)acrylate are preferable from the perspectives of superior effect of the present technology and excellent adhesion and stability.

### (Meth)Acrylic Acid Alkyl Ester Monomer (A6)

The (meth)acrylic acid alkyl ester monomer (A6) as the polymerizable monomer (A) may be any alkyl ester of (meth)acrylic acid.

The (meth)acrylic acid alkyl ester monomer (A6) is synonymous with the (meth)acrylic acid alkyl ester monomer (A3) described above.

Among these, methyl (meth)acrylate, ethyl (meth)acrylate, n-butyl (meth)acrylate, isobutyl (meth)acrylate, sec-butyl (meth)acrylate, t-butyl (meth)acrylate, 2-ethylhexyl (meth)acrylate, and the like are preferable. (Meth)acrylic acid monomer (A7)

Examples of the (meth)acrylic acid monomer (A7) as the polymerizable monomer (A) include (meth)acrylic acid.

### Hydroxy Group-Containing Polymerizable Monomer (A8)

The hydroxy group-containing polymerizable monomer (A8) as the polymerizable monomer (A) may be any compound having a (meth)acryloyl group and a hydroxy group.

The hydroxy group-containing polymerizable monomer (A8) is synonymous with the hydroxy group-containing polymerizable monomer (A5) described above.

### Quantitative Ratio of Monomers

### AP/A6

The molar ratio (AP/A6) of the phosphoric acid group-containing polymerizable monomer (AP) to the (meth)acrylic acid alkyl ester monomer

(A6) is preferably 0.04 or less, and more preferably from 0.001 to 0.04, from the perspective of achieving superior effect of the present technology and excellent adhesion.

### A7/A6

The molar ratio (A7/A6) of the (meth)acrylic acid monomer (A7) to the (meth)acrylic acid alkyl ester monomer (A6) is preferably from 0.05 to 0.20, and more preferably from 0.05 to 0.15, from the perspective of achieving superior effect of the present technology and excellent adhesion and stability.

### A8/A6

The molar ratio (A8/A6) of the hydroxy group-containing polymerizable monomer (A8) to the (meth)acrylic acid alkyl ester monomer (A6) is preferably from 0.01 to 0.20, and more preferably from 0.05 to 0.10, from the perspective of achieving superior effect of the present technology and excellent adhesion. Content of phosphoric acid group-containing polymerizable monomer (AP)

The (meth)acrylic acid alkyl ester monomer (A6), the (meth)acrylic acid monomer (A7), and the hydroxy group-containing polymerizable monomer (A8) is preferably from 0.1 to 3 mol %, and more preferably from 0.5 to 2.5 mol % from the perspective of achieving superior effect of the present technology and excellent adhesion and stability, the content of the phosphoric acid group-containing polymerizable monomer (AP) relative to the total number of moles of the phosphoric acid group-containing polymerizable monomer (AP).

### Production Method of (Meth)Acrylic Emulsion

The production method of (meth)acrylic emulsion is not limited. Examples thereof include a method in which a polymerizable monomer (A) is polymerized in the presence of a polymerization initiator in a dispersion medium such as water to obtain a (meth)acrylic emulsion in which (meth)acrylic particles are dispersed as a dispersoid.

The polymerization initiator used in the production method may be any compound that can subject a monomer having a vinyl-based functional group, such as a (meth)acryloyl group, to radical polymerization. Examples thereof include azo compounds, such as 2,2′-azobisbutyronitrile (AIBN); and peroxides such as benzoyl peroxide (BPO).

The polymerization initiator can be used alone or in combination of two or more types thereof.

The used amount of the polymerization initiator is preferably from 0.002 to 1 mol % relative to the total number of moles of all the monomers (A1) to (A5) or the total number of moles of all of the monomer (AP) and monomers (A6) to (A8).

The dispersion medium used in the production method is synonymous with that described above. The used amount of the dispersion medium may be from 60 to 700 parts by mass per 100 parts by mass of the polymerizable monomer (A).

The reaction temperature in the production method may be from 60 to 80° C.

The polymerization can be performed with agitation.

In the production method, a neutralizer may be further used.

Any neutralizer that can neutralize an acidic group, such as a carboxy group and a phosphoric acid group may be used. Examples thereof include sodium hydroxide, potassium hydroxide; ammonia water; and tertiary amines (B) described below.

The neutralizer is preferably used in an amount such that, for example, the pH value of the emulsion after the neutralization becomes from approximately 7 to 10.

In the production method, for example, vinyl monomers except the polymerizable monomer (A); reducing agents and chain transfer agents may be further used.

### Tertiary Amine (B)

The tertiary amine (B) contained in the composition of an embodiment of the present technology may be any compound in which three hydrocarbon groups that may have a heteroatom are bonded to a nitrogen atom.

The tertiary amine (B) may form a salt (e.g. a carboxylate, a phosphate) by reacting with at least one type selected from the group consisting of a carboxy group and a phosphoric acid group contained in the (meth)acrylic particle.

When the polymerizable monomer (A) is the second monomer composition and the tertiary amine (B) forms a salt by reacting with the carboxy group and the phosphoric acid group, superior effect of the present technology is achieved and excellent adhesion is achieved because the particle size of the (meth)acrylic particle becomes smaller.

When the polymerizable monomer (A) is the first monomer composition, and the composition in this case is used as a primer, the tertiary amine (B) can produce a hydroxy group by reacting with an epoxy group contained in the (meth)acrylic particle.

The hydrocarbon group that may have a heteroatom is not limited. Examples thereof include the groups listed above. Specific examples thereof include an aliphatic hydrocarbon group that may have a hydroxy group.

Examples of the tertiary amine (B) include trimethylamine, triethylamine, tri-n-propylamine, tributylamine, and triethanolamine.

The tertiary amine (B) can be used alone or in combination of two or more types thereof.

### Content of Tertiary Amine (B)

### B/A4

When the polymerizable monomer (A) is the first monomer composition, the content of the tertiary amine (B) is preferably an amount by which the molar ratio (B/A4) of the tertiary amine (B) to the (meth)acrylic acid monomer (A4) used in the production of the (meth)acrylic emulsion becomes from 0.2 to 1.0, and more preferably from 0.3 to 1.0 from the perspective of achieving superior effect of the present technology and excellent stability.

### B/A7

When the polymerizable monomer (A) is the second monomer composition, the content of the tertiary amine (B) is preferably an amount by which the molar ratio (B/A7) of the tertiary amine (B) to the (meth)acrylic acid monomer (A7) used in the production of the (meth)acrylic emulsion becomes from 0.1 to 1.0, and more preferably from 0.3 to 1.0 from the perspective of achieving superior effect of the present technology and excellent adhesion and stability.

### Optional Component

The composition according to an embodiment of the present technology may further contain additives as necessary in a range that does not inhibit the object and effect of the present technology. Examples of the additive include emulsions except the predetermined (meth)acrylic emulsion; amines except the tertiary amine; fillers, pigments, antiblocking agents, dispersion stabilizers, thixotropic agents, viscosity modifiers, leveling agents, antigelling agents, photostabilizers, anti-aging agents, antioxidants, UV absorbents, plasticizers, lubricants, antistatic agents, reinforcing materials, flame retardants, catalysts, antifoaming agents, thickeners, dispersants, and organic solvents. The type and the used amount of the additives may be selected as desired.

### Production Method

The production method of the composition of an embodiment of the present technology is not limited.

For example, the composition of an embodiment of the present technology can be produced by mixing the (meth)acrylic emulsion, the tertiary amine (B), and additives that may be used as necessary.

The composition of an embodiment of the present technology may be produced by using the tertiary amine (B) during the production of (meth)acrylic emulsion. In this case, the obtained (meth)acrylic emulsion can be used as is as a composition of an embodiment of the present technology.

Furthermore, when the tertiary amine (B) is used during the production of (meth)acrylic emulsion, the composition of an embodiment of the present technology can be produced by further mixing the additives that may be used as necessary to the obtained (meth)acrylic emulsion.

### Use

The composition of an embodiment of the present technology can be used as a primer composition for a sealant.

Examples of the adherend to which the composition of an embodiment of the present technology can be applied include glass; metals such as aluminum, anodized aluminum, iron, galvanized steel plates, copper, and stainless steel; inorganic hard materials (foundation) such as mortar and stone materials; porous members such as mortar; coated members that are coated with fluoro electrodeposition, acrylic electrodeposition, fluorine coating, urethane coating, and acrylic urethane coating; cured products (e.g. waterproof material) of sealants such as silicone-based, modified silicone-based, urethane-based, polysulfide-based, and polyisobutylene-based sealants; vinyl chloride resins, acrylic resins; rubbers such as acrylonitrile butadiene rubber (NBR) and ethylene-propylene-diene rubber (EPDM); and the like.

### Method of Use

The method of using the composition of an embodiment of the present technology is exemplified by a method including: applying the composition of an embodiment of the present technology onto the adherend described above; optionally drying the composition; applying a sealant composition thereto; and then curing the composition of an embodiment of the present technology and the sealant composition.

The temperature at which the composition of an embodiment of the present technology is dried is preferably 20° C. or higher from the perspective of achieving superior effect of the present technology and excellent adhesion and workability.

The used sealant is not limited. Examples thereof include sealants for construction and automobiles. Specific examples thereof include silicone-based sealant, modified silicone-based sealant, polyurethane-based sealant, polysulfide-based sealant, and polyisobutylene-based sealant. Among these, polyurethane-based sealant, and especially polyurethane-based sealant for construction (urethane waterproof material) can be preferably used.

### EXAMPLES

The present technology is described below in detail using examples but the present technology is not limited to such examples. Production of (meth)acrylic emulsion

Components shown in the rows of production of the (meth)acrylic emulsion shown in Table 1 below were charged in a reaction vessel in the molar ratio shown in the same table, and distilled water was added thereto. The mixture was heated to 80° C., and then polymerization was performed by agitating for 5 hours to obtain each of (meth)acrylic emulsions Em 1 to 6.

Components shown in the rows of production of the (meth)acrylic emulsion shown in Table 2 below were charged in a reaction vessel in the molar ratio shown in the same table, and distilled water was added thereto. The mixture was heated to 80° C., and then polymerization was performed by agitating for 5 hours to obtain each of (meth)acrylic emulsions Em 1 to 5.

### Production of Water-Based Primer Composition

Into each of the (meth)acrylic emulsions obtained as described above, the tertiary amine (B) in Table 1 or 2 below was added in the molar ratio shown in the same table and agitated to produce a water-based primer composition.

Note that, in Table 1 or 2, the solid content is the total amount (mass %) of the monomer used in the production of the (meth)acrylic emulsion relative to the total amount of the water-based primer composition.

### Evaluation

The following tests were conducted to evaluate the water resistance of each of the water-based primer compositions produced as described above. Furthermore, adhesion was also evaluated. The results are shown in Table 1 or 2 below. Note that stability test was only performed for Table 1.

### Preparation of Initial Test Piece

Each of the water-based primer compositions was applied on mortar which was an adherend (50 mm length×50 mm width; available from Paltek Corporation) by using a brush in a manner that the film thickness was 50 g/m² and dried at 25° C. for 3 hours to form a primer layer. Thereafter, a urethane waterproof material (trade name: HAMATITE URBAN ROOF U-8000, available from The Yokohama Rubber Co., Ltd.; urethane waterproof material) was poured onto the primer layer in a manner that the thickness was 5 mm, and the urethan waterproof material was cured in a condition at 25° C. and a relative humidity of 45% for 3 days to obtain an initial test piece.

### Separation Test in Normal State

### Separation Test in Normal State

The separation test in a normal state was performed by holding an edge of the urethane waterproof material of the initial test piece obtained as described above by a hand and peeling off the urethane waterproof material from the initial test piece at an angle of 180° in a condition at 23° C. The results of the separation test in a normal state were evaluated based on the following evaluation criteria.

### Evaluation Criteria of Separation Test in Normal State

In the case where the failure form of the adhesion interface after the separation test in a normal state was cohesive failure of the entire primer (hereinafter, this is also referred to as “CF100”), the case was evaluated as exhibiting excellent adhesion and indicated as “A”. Note that the value after the “CF” indicates the percentage of the area occupied by the cohesive failure (CF) relative to the entire area where the adhesion was broken (the same applies hereinafter).

In the case where the failure form of the adhesion interface after the separation test in a normal state was partial interfacial failure (20% or less relative to the total broken area) and cohesive failure of the primer, the case was evaluated as exhibiting poor adhesion and indicated as “B”. Hereinafter, the failure state described above is referred to as “CF80 or greater but less than 100”.

### Water Resistant Separation Test

An initial test piece produced in the same manner as described above was immersed in water at 25° C. for a week, and then the test piece was taken out from the water, and this was used as a test piece for water resistance evaluation.

### Water Resistant Separation Test

The water resistant separation test was performed by holding an edge of the urethane waterproof material of the test piece for water resistance evaluation obtained as described above by a hand and peeling off the urethane waterproof material from the test piece for water resistance evaluation at an angle of 180° in a condition at 23° C. The results of the water resistant separation test were evaluated based on the following evaluation criteria.

### Evaluation Criteria of Water Resistant Separation Test

In the case where the failure form of the adhesion interface after the water resistant test was cohesive failure of the entire primer (CF100), the case was evaluated as exhibiting significantly excellent water resistance and indicated as “A”.

In the case where the failure form was CF80 or greater but less than 100, the case was evaluated as exhibiting somewhat good water resistance and indicated as “B”.

In the case where the failure form was CF60 or greater but less than 80, the case was evaluated as exhibiting somewhat poor water resistance and indicated as “C”.

In the case where the urethane waterproof material was easily peeled off from the test piece for water resistance evaluation or the failure form was less than CF60, the case was evaluated as exhibiting poor water resistance and indicated as “D”.

### Stability Test

### Preparation of Test Piece for Stability Test Evaluation

First, the water-based primer composition produced as described above was stored in a condition at 50° C. and a relative humidity of 45% for 5 days. The water-based primer composition after the storage was visually observed.

Thereafter, a test piece was prepared by the same procedure as the preparation of the initial test piece described above except for using the water-based primer composition after the storage, and the obtained test piece was used as the test piece for stability test evaluation.

Note that the water-based primer composition after the storage was visually observed, and only the composition having no precipitation was used for the preparation of the test piece for stability test evaluation.

### Separation Test

The separation test was performed by holding an edge of the urethane waterproof material of the test piece for stability test evaluation obtained as described above by a hand and peeling off the urethane waterproof material from the test piece for stability test evaluation at an angle of 180° in a condition at 23° C. The results of the separation test were evaluated based on the following evaluation criteria.

### Evaluation Criteria of Separation Test

In the case where the urethane waterproof material was not peeled off from the test piece for stability test evaluation, the case was evaluated as exhibiting significantly excellent stability and indicated as “A”.

In the case of CF100 or CF80 or greater but less than 100, the case was evaluated as exhibiting somewhat good stability and indicated as “B”.

In the case where the failure form was CF60 or greater but less than 80, the case was evaluated as exhibiting somewhat poor stability and indicated as “C”.

In the case where the urethane waterproof material was easily peeled off from the test piece for stability test evaluation or the failure form was less than CF60, the case was evaluated as exhibiting poor stability and indicated as “D”.

In the case where precipitation was observed in the composition as a result of the visual observation of the water-based primer composition after the storage, the case was evaluated as exhibiting significantly poor stability and indicated as “E”.

TABLE 1

| | | | |
|---|---|---|---|
| Mw | Example 1 | Example 2 | Example 3 |

Production of (meth)acrylic emulsion (molar ratio)

| | | | | | |
|---|---|---|---|---|---|
| Monomer (A1-1) | GMA | 142.15 | 0.08 | 0.08 | 0.08 |
| Monomer (A2-1) | KBE-502 | 260.4 | 0.02 | 0.04 | 0.10 |
| Monomer (A3-1) | MMA | 100.12 | 1.00 | ← | ← |
| Monomer (A3-2) | 2EHA | 184.28 | 0.20 | ← | ← |
| Monomer (A4-1) | MAA | 86.09 | 0.15 | ← | ← |
| Monomer (A5-1) | HEMA | 130.14 | 0.10 | ← | ← |
| Polymerization initiator | AIBN | 164.21 | 0.01 | ← | ← |

| | | | |
|---|---|---|---|
| A1/A3 | 0.067 | 0.067 | 0.067 |
| A2/A3 | 0.02 | 0.03 | 0.08 |
| A4/A3 | 0.13 | ← | ← |
| A5/A3 | 0.08 | ← | ← |
| (A1 + A2 + A3 + A4 + A5) | 1.56 | 1.58 | 1.64 |
| A1/(A1 + A2 + A3 + A4 + A5) (mol %) | 5 | 5 | 5 |
| (A1 + A2)/(A1 + A2 + A3 + A4 + A5) (mol %) | 6 | 8 | 11 |
| Produced (meth)acrylic emulsion | Em 1 | Em 2 | Em 3 |

Production of water-based primer composition

| (Meth)acrylic emulsion used in production of composition | | | Em 1 | Em 2 | Em 3 |
|---|---|---|---|---|---|
| Tertiary amine (B-1) | TEA | 101.19 | 0.05 | ← | ← |
| (molar ratio) | | | | | |

| Solid content (mass %) | | 40% | 40% | 40% |
|---|---|---|---|---|
| Separation test in normal state | | A | A | A |
| Water resistant separation test | | C | B | B |
| Stability test | | B | B | E |
| | | | | Comparative |
| | Mw | Example 4 | Example 5 | Example 1 |

Production of (meth)acrylic emulsion (molar ratio)

| | | | | | |
|---|---|---|---|---|---|
| Monomer (A1-1) | GMA | 142.15 | 0.05 | 0.12 | |
| Monomer (A2-1) | KBE-502 | 260.4 | 0.02 | 0.02 | 0.02 |
| Monomer (A3-1) | MMA | 100.12 | ← | ← | ← |
| Monomer (A3-2) | 2EHA | 184.28 | ← | ← | ← |
| Monomer (A4-1) | MAA | 86.09 | ← | ← | ← |
| Monomer (A5-1) | HEMA | 130.14 | ← | ← | ← |
| Polymerization initiator | AIBN | 164.21 | ← | ← | ← |

| | | | |
|---|---|---|---|
| A1/A3 | 0.042 | 0.10 | — |
| A2/A3 | 0.02 | 0.02 | 0.02 |
| A4/A3 | ← | ← | ← |
| A5/A3 | ← | ← | ← |
| (A1 + A2 + A3 + A4 + A5) | 1.54 | 1.61 | 1.48 |
| A1/(A1 + A2 + A3+ A4 + A5) (mol %) | 3 | 7 | — |
| (A1 + A2)/(A1 + A2 + A3 + A4 + A5) (mol %) | 5 | 9 | 1 |
| Produced (meth)acrylic emulsion | Em 4 | Em 5 | Em 6 |

Production of water-based primer composition

| (Meth)acrylic emulsion used in production of composition | | | Em 4 | Em 5 | Em 6 |
|---|---|---|---|---|---|
| Tertiary amine (B-1) | TEA | 101.19 | ← | ← | ← |
| (molar ratio) | | | | | |

| | | | |
|---|---|---|---|
| Solid content (mass %) | 40% | 40% | 40% |
| Separation test in normal state | A | A | A |
| Water resistant separation test | C | C | D |
| Stability test | A | B | A |

Details of the components described in Table 1 are as follows.

### Production of (Meth)Acrylic Emulsion

Monomer (A1-1): glycidyl methacrylate (GMA, having the following structure), available from Tokyo Chemical Industry Co., Ltd. Monomer (A1-1) corresponds to an epoxy group-containing polymerizable monomer (A1).

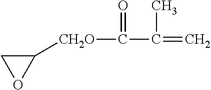

Monomer (A2-1): γ-methacryloxypropyl methyldiethoxysilane (having the following structure), KBE-502, available from Shin-Etsu Chemical Co., Ltd. Monomer (A2-1) corresponds to a (meth)acrylic silane coupling agent (A2).

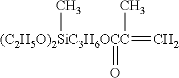

Monomer (A3-1): methyl methacrylate (MMA). Monomer (A3-1) corresponds to a (meth)acrylic acid alkyl ester monomer (A3).

Monomer (A3-2): 2-ethylhexyl acrylate (2EHA). Monomer (A3-2) corresponds to a (meth)acrylic acid alkyl ester monomer (A3).

Monomer (A4-1): methacrylic acid (MAA). Monomer (A4-1) corresponds to a (meth)acrylic acid monomer (A4).

Monomer (A5-1): 2-hydroxyethyl methacrylate (HEMA). Monomer (A5-1) corresponds to a hydroxy group-containing polymerizable monomer (A5).

Polymerization initiator: 2,2′-azobisisobutyronitrile (AIBN).

### Production of Water-Based Primer Composition

(Meth)acrylic emulsions Em 1 to 6 used in the production of the compositions: Em 1 to 6 produced as described above.

Tertiary amine (B-1): triethylamine (TEA)

As is clear from the results shown in Table 1, Comparative Example 1, in which the polymerizable monomer (A) contained no epoxy group-containing polymerizable monomer (A1), exhibited poor water resistance.

On the other hand, it was confirmed that the compositions of embodiments of the present technology exhibited a predetermined effect.

When Examples 2 and 3 are compared with Example 1, it was found that superior water resistance can be achieved when A2/A3 was greater than 0.02.

When Examples 1 and 2 are compared with Example 3, it was found that excellent stability can be achieved when A2/A3 was less than 0.08.

When Example 4 and Examples 1 and 5 are compared, it was found that excellent stability can be achieved when A1/A3 was less than 0.060.

TABLE 2

| | Example | Example | Example | Example | Comparative |
|---|---|---|---|---|---|
| Mw | 1 | 2 | 3 | 4 | Example 1 |

Production of (meth)acrylic emulsion (molar ratio)

| | | | | | | | |
|---|---|---|---|---|---|---|---|
| Monomer (A6-1) | MMA | 100.12 | 1.00 | ← | ← | ← | ← |
| Monomer (A6-2) | 2EHA | 184.28 | 0.20 | ← | ← | ← | ← |
| Monomer (A7-1) | MAA | 86.09 | 0.12 | ← | ← | ← | ← |
| Monomer (A8-1) | HEMA | 130.14 | 0.08 | ← | ← | ← | ← |
| Monomer (AP-1) | Phosmer PP | 477 | 0.01 | 0.02 | 0.03 | | |
| Monomer (AP-2) | Light ester | 210 | | | | 0.02 | |
| | P-1M | | | | | | |
| Polymerization | AIBN | 164.21 | 0.01 | ← | ← | ← | ← |
| initiator | | | | | | | |

| | | | | | |
|---|---|---|---|---|---|
| AP/A6 | 0.008 | 0.020 | 0.03 | 0.02 | — |
| A7/A6 | 0.10 | 0.10 | 0.10 | 0.10 | 0.10 |
| A8/A6 | 0.07 | 0.07 | 0.07 | 0.07 | 0.07 |
| (A6 + A7 + A8 + AP) | 1.42 | 1.43 | 1.44 | 1.43 | 1.41 |
| AP/(A6 + A7 + A8 + AP) | 0.7 | 1.4 | 2.1 | 1.4 | — |
| (mol %) | | | | | |
| Produced (meth)acrylic emulsion | Em 1 | Em 2 | Em 3 | Em 4 | Em 5 |

Production of water-based primer composition

| (Meth)acrylic emulsion used in | | | Em 1 | Em 2 | Em 3 | Em 4 | Em 5 |
|---|---|---|---|---|---|---|---|
| production of composition | | | | | | | |
| Tertiary amine (B-1) | TEA | 101.19 | 0.1 | ← | ← | 0.05 | 0.05 |
| (molar ratio) | | | | | | | |

| | | | | | |
|---|---|---|---|---|---|
| Solid content (mass %) | 30% | 30% | 30% | 30% | 30% |
| Separation test in normal state | A | A | A | A | B |
| Water resistant separation test | C | B | B | B | D |

Details of the components described in Table 2 are as follows. Production of (meth)acrylic emulsion

Monomer (A6-1): methyl methacrylate (MMA). Monomer (A6-1) corresponds to a (meth)acrylic acid alkyl ester monomer (A6).

Monomer (A6-2): 2-ethylhexyl acrylate (2EHA). Monomer (A6-2) corresponds to a (meth)acrylic acid alkyl ester monomer (A6).

Monomer (A7-1): methacrylic acid (MAA). Monomer (A7-1) corresponds to a (meth)acrylic acid monomer (A7).

Monomer (A8-1): 2-hydroxyethyl methacrylate (HEMA). Monomer (A8-1) corresponds to a hydroxy group-containing polymerizable monomer (A8).

Monomer (AP-1): acid phosphoxy polyoxypropylene glycol mono(meth)acrylate (having the following structure), available from Uni Chemical K.K. Monomer (AP-1) corresponds to a phosphoric acid group-containing polymerizable monomer (AP).

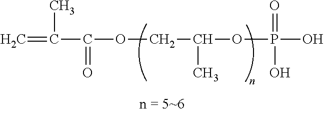

Monomer (AP-2): 2-methacryloyloxyethyl acid phosphate (having the following structure), available from Kyoeisha Chemical Co., Ltd. Monomer (AP-2) corresponds to a phosphoric acid group-containing polymerizable monomer (AP).

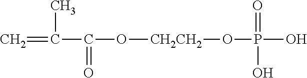

Polymerization initiator: 2,2′-azobisisobutyronitrile (AIBN). Production of water-based primer composition

(Meth)acrylic emulsions Em 1 to 5 used in the production of the compositions: Em 1 to 5 produced as described above.

Tertiary amine (B-1): triethylamine (TEA)

As is clear from the results shown in Table 2, Comparative Example 1, in which the polymerizable monomer (A) contained no phosphoric acid group-containing polymerizable monomer (AP), exhibited poor adhesion and water resistance.

On the other hand, it was confirmed that the compositions of embodiments of the present technology exhibited a predetermined effect. Furthermore, the compositions of embodiments of the present technology exhibited excellent adhesion.

When Examples 2 to 4 are compared with Example 1, it was found that superior water resistance can be achieved when AP/A6 was 0.01 or greater.

1. A water-based primer composition for a sealant, the water-based primer composition comprising a (meth)acrylic emulsion containing a (meth)acrylic particle and a tertiary amine (B),
the (meth)acrylic particle being a particle of a polymer obtained by polymerizing a polymerizable monomer (A) having a (meth)acryloyl group;
the polymerizable monomer (A) containing an epoxy group-containing polymerizable monomer (A1) having an epoxy group, a (meth)acrylic silane coupling agent (A2), a (meth)acrylic acid alkyl ester monomer (A3), a (meth)acrylic acid monomer (A4), and a hydroxy group-containing polymerizable monomer (A5) having a hydroxy group, or
the polymerizable monomer (A) containing a phosphoric acid group-containing polymerizable monomer (AP) having a phosphoric acid group, a (meth)acrylic acid alkyl ester monomer (A6), a (meth)acrylic acid monomer (A7), and a hydroxy group-containing polymerizable monomer (A8) having a hydroxy group, and
a content of the (meth)acrylic particle being from 15 to 60 mass %.

2. The water-based primer composition for a sealant according to claim 1, wherein a molar ratio (A1/A3) of the epoxy group-containing polymerizable monomer (A1) to the (meth)acrylic acid alkyl ester monomer (A3) is from 0.02 to 0.12.

3. The water-based primer composition for a sealant according to claim 1, wherein a molar ratio (A2/A3) of the (meth)acrylic silane coupling agent (A2) to the (meth)acrylic acid alkyl ester monomer (A3) is from 0.01 to 0.07.

4. The water-based primer composition for a sealant according to claim 1, wherein a molar ratio (A4/A3) of the (meth)acrylic acid monomer (A4) to the (meth)acrylic acid alkyl ester monomer (A3) is from 0.05 to 0.2.

5. The water-based primer composition for a sealant according to claim 1, wherein a molar ratio (A5/A3) of the hydroxy group-containing polymerizable monomer (A5) to the (meth)acrylic acid alkyl ester monomer (A3) is from 0.08 to 0.18.

6. The water-based primer composition for a sealant according to claim 1, wherein a molar ratio (B/A4) of the tertiary amine (B) to the (meth)acrylic acid monomer (A4) is from 0.2 to 1.0.

7. The water-based primer composition for a sealant according to claim 1, wherein a molar ratio (AP/A6) of the phosphoric acid group-containing polymerizable monomer (AP) to the (meth)acrylic acid alkyl ester monomer (A6) is 0.04 or less.

8. The water-based primer composition for a sealant according to claim 1, wherein a molar ratio (A7/A6) of the (meth)acrylic acid monomer (A7) to the (meth)acrylic acid alkyl ester monomer (A6) is from 0.05 to 0.15.

9. The water-based primer composition for a sealant according to claim 1, wherein a molar ratio (A8/A6) of the hydroxy group-containing polymerizable monomer (A8) to the (meth)acrylic acid alkyl ester monomer (A6) is from 0.05 to 0.1.

10. The water-based primer composition for a sealant according to claim 1, wherein a molar ratio (B/A7) of the tertiary amine (B) to the (meth)acrylic acid monomer (A7) is from 0.1 to 1.0.

11. The water-based primer composition for a sealant according to claim 2, wherein a molar ratio (A2/A3) of the (meth)acrylic silane coupling agent (A2) to the (meth)acrylic acid alkyl ester monomer (A3) is from 0.01 to 0.07.

12. The water-based primer composition for a sealant according to claim 2, wherein a molar ratio (A4/A3) of the (meth)acrylic acid monomer (A4) to the (meth)acrylic acid alkyl ester monomer (A3) is from 0.05 to 0.2.

13. The water-based primer composition for a sealant according to claim 2, wherein a molar ratio (A5/A3) of the hydroxy group-containing polymerizable monomer (A5) to the (meth)acrylic acid alkyl ester monomer (A3) is from 0.08 to 0.18.

14. The water-based primer composition for a sealant according to claim 2, wherein a molar ratio (B/A4) of the tertiary amine (B) to the (meth)acrylic acid monomer (A4) is from 0.2 to 1.0.

15. The water-based primer composition for a sealant according to claim 7, wherein a molar ratio (A7/A6) of the (meth)acrylic acid monomer (A7) to the (meth)acrylic acid alkyl ester monomer (A6) is from 0.05 to 0.15.

16. The water-based primer composition for a sealant according to claim 7, wherein a molar ratio (A8/A6) of the hydroxy group-containing polymerizable monomer (A8) to the (meth)acrylic acid alkyl ester monomer (A6) is from 0.05 to 0.1.

17. The water-based primer composition for a sealant according to claim 7, wherein a molar ratio (B/A7) of the tertiary amine (B) to the (meth)acrylic acid monomer (A7) is from 0.1 to 1.0.
